(19) United States
(12) Patent Application Publication
(10) Pub. No.: US 2006/0224691 A1
(43) Pub. Date: Oct. 5, 2006

(54) Transparent rendering of media to remote client

(75) Inventors: Pronay Dutta, Beaverton, OR (US); Ylian Saint-Hilaire, Hillsboro, OR (US)

Correspondence Address: SCHWABE, WILLIAMSON & WYATT, PACWEST CENTER, SUITE 1900, 1211 S.W. FIFTH AVE., PORTLAND, OR, 97204, US

(73) Assignee: Intel Corporation

(21) Appl. No.: 11/100,187

(22) Filed: Apr. 5, 2005

(51) Int. Cl. G06F 15/16

(52) U.S. Cl. 709/217

(57) ABSTRACT

An apparatus, including a media service access module, and methods practiced thereon, for transparently facilitating a media rendering application to render a media file to a remote client device, are described herein.

### FIELD OF THE INVENTION

Embodiments of the present invention relate to the field of data processing. More specifically, some embodiments of the present invention are related to rendering media from a UPNP server to a UPNP client.

### BACKGROUND

Advances in microprocessor related technology have lead to widespread development and the adoption of computing devices. Computing powers that used to be available only in expensive mainframe computers requiring special operating environments are now available in many personal-computing devices. The form factors vary from desktop, laptop, palm sized and so forth. A number of these computing devices are packaged as “purpose” devices, such as set-top boxes, entertainment personal digital assistants (“PDA”), pagers, text messengers, smart appliances and wireless mobile phones.

Concurrently, advances in networking, telecommunications and related technologies, in particular, in the area of wireless networking/communications, have led to increased connectivity between computing devices, over local, private, wide area, and/or public networks. Of particular notoriety is the Internet.

Together, these and other related factors contributed to the availability of rich content and functionality available from a variety of server devices for consumption and/or application on a variety of client devices, in a standalone or connected manner.

Recently, this trend of consumption/application of content and services has made significant advances in the home operating environment. Some desktop computers and set-top boxes are equipped with hardware and software that are designed to locally provide the end users with rich multi-media experience, including facilities that assist the development and provision of such multi-media experience. An example is what is referred to as the Media Center PC equipped with sufficient hardware resources, and an operating system having rich media services for multi-media applications executing thereon to locally render media.

Further, to facilitate interchangeability and ease of employment of a wide range of devices to interact with such content and services, the UPNP networking and a number of related technologies are being developed by members of the UPNP Forum. These specifications specify the protocols and services to be supported by UPNP devices in UPNP networks.

However, these specifications do not specify the user interface through which UPNP client devices will interact with UPNP servers. Furthermore, there is no indication of how UPNP client devices will obtain appropriate user interfaces through which their operations are to be controlled. Still further, there is no specification for how multi-media applications can leverage on the media services available on the server (or media service rich desktop computer/set-top boxes) and render media onto the remote client devices.

### BRIEF DESCRIPTION OF THE DRAWINGS

The present invention will be described by way of exemplary embodiments but not limitations, illustrated in the accompanying drawings in which like references denote similar elements, and in which:

FIG. 1 illustrates a system view of an example operating environment suitable for use to practice the present invention, in accordance with various embodiments.

FIG. 2 illustrates an architectural view of a device suitable for use as an UPNP server, in accordance with various embodiments.

FIG. 3 illustrates an overview of the protocol and methods for the UPNP server to interact with and control the UPNP client device, in accordance with various embodiments.

FIG. 4 illustrates the operational flow of selected aspects of a process at the UPNP server for rendering display images to a remote UPNP client device, in accordance with various embodiments.

FIG. 5 illustrates the operational flow of selected aspects of a process at the UPNP server for transparently facilitating a media rendering application in rendering media to a remote UPNP client device, in accordance with various embodiments.

### DETAILED DESCRIPTION

In the following detailed description, reference is made to the accompanying drawings which form a part hereof wherein like numerals designate like parts throughout, and in which are shown, by way of illustration, specific embodiments in which the invention may be practiced. It is to be understood that other embodiments may be utilized and structural or logical changes may be made without departing from the scope of the present invention. Therefore, the following detailed description is not to be taken in a limiting sense, and the scope of the present invention is defined by the appended claims and their equivalents.

Embodiments of the present invention include a user and developer friendly technique for rendering media from a UPNP server to a remote UPNP client device. The operation may also be referred to as remoting media or display images from a UPNP server to a UPNP client device.

In the following description, various aspects of the present invention will be described. However, it will be apparent to those of ordinary skill in the art and others that the present invention may be practiced with only some or all of the aspects of the present invention. For purposes of explanation, specific numbers, materials and configurations are set forth in order to provide a thorough understanding of the present invention. However, it will be apparent to those of ordinary skill in the art and others that the present invention may be practiced without the specific details. In other instances, well-known features are omitted or simplified in order not to obscure the present invention.

The various operations will be described as multiple discreet steps in turn, in a manner that is most helpful to understanding of the present invention. However, the order of description should not be construed to imply that these operations are necessarily order dependent. In particular, these operations may not be performed in the order of presentation.

The phrase “in one embodiment” is used repeatedly. The phrase generally does not refer to the same embodiment, however, it may. The terms “comprising,” “having” and “including” are synonymous, unless the context dictates otherwise.

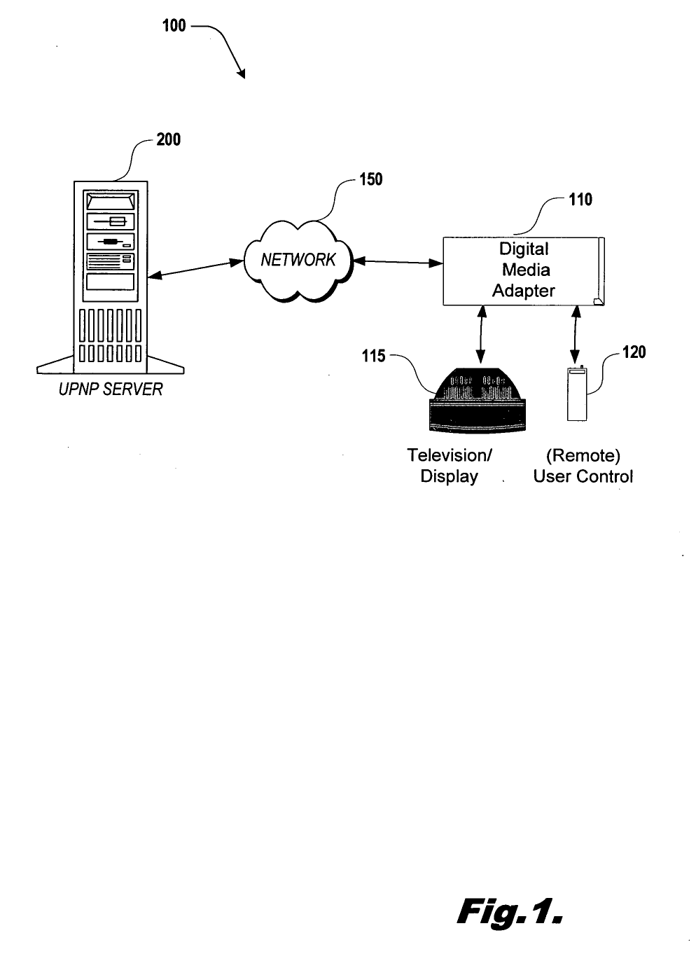

Referring now to FIG. 1, wherein an overview of an example operating environment incorporated with the teachings of the present invention, in accordance with one embodiment, is shown. As illustrated, example operating environment 100 includes server 200, a network 150, client 110, display 115, and remote control 120, operationally coupled to each other, as shown, via a network 150. In various embodiments, server 200 and client device 110 are UPNP compliant or compatible devices. Further, in various embodiments, client device 110 is a UPNP digital media adapter (DMA) client device, for interfacing UPNP server 200 to display 115 and remote control 120. In various embodiments, display 115 and remote control 120 may or may not be UPNP compliant or compatible devices. In various embodiments, display 115 and remote control 120 may be conventional television and remote control, respectively. In alternate embodiments, client device 110 may be integrated with display 115.

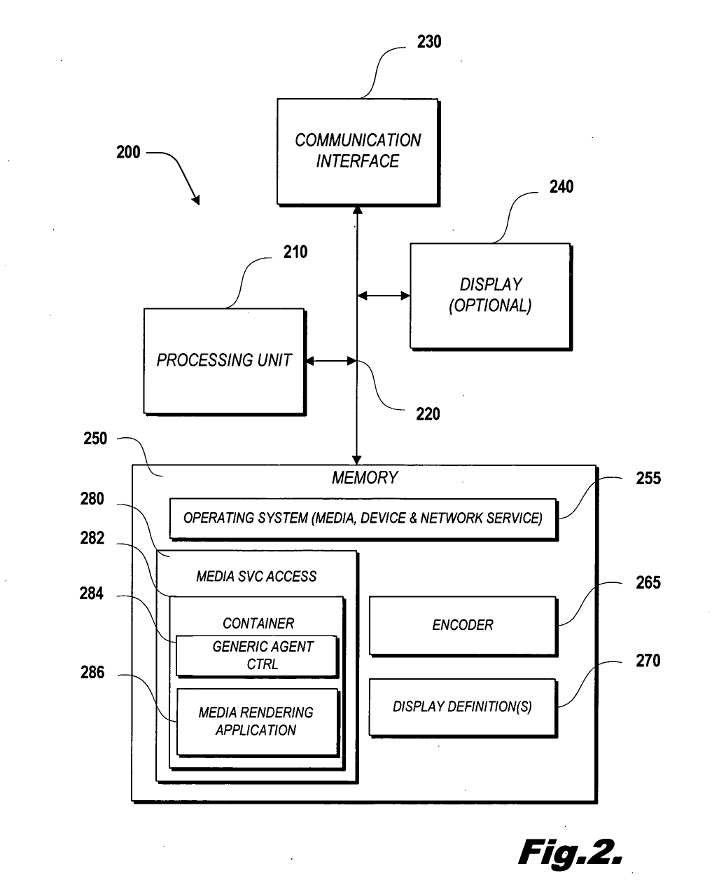

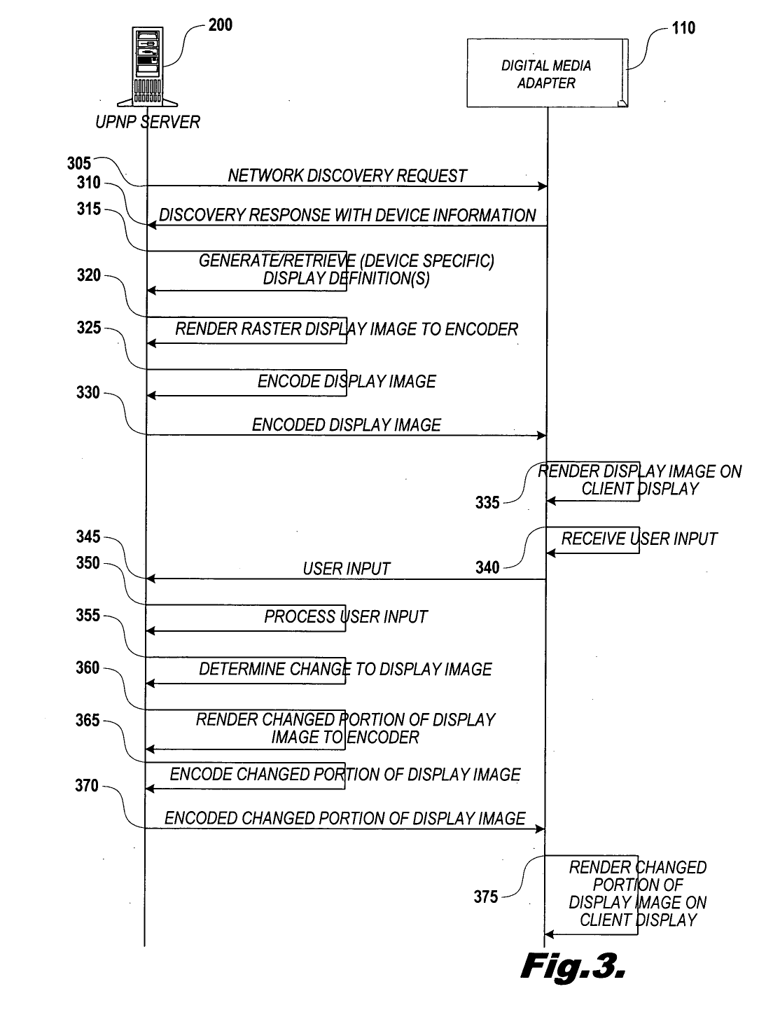

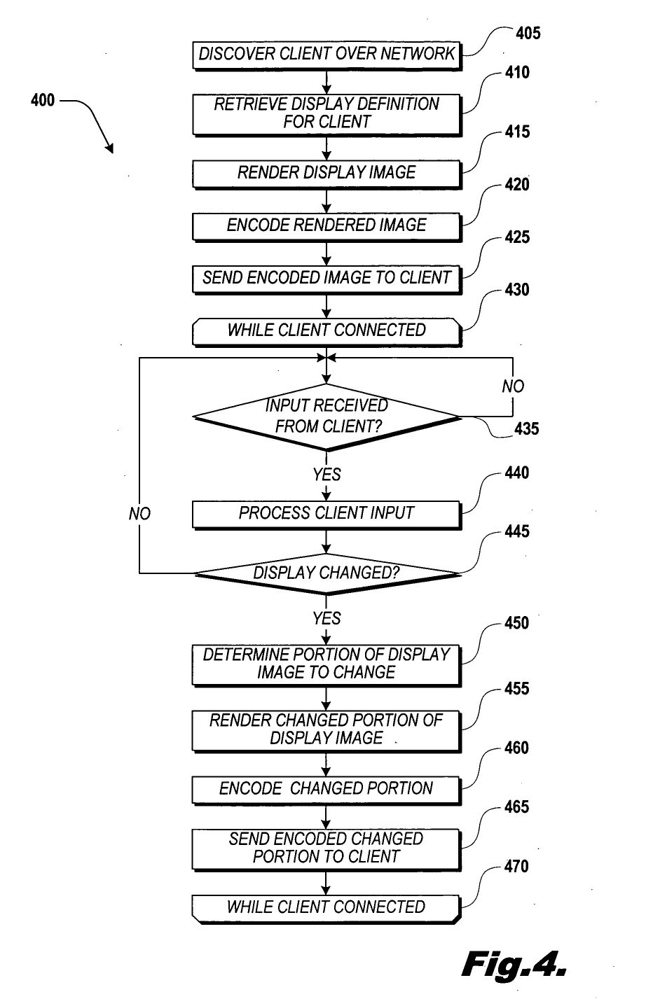

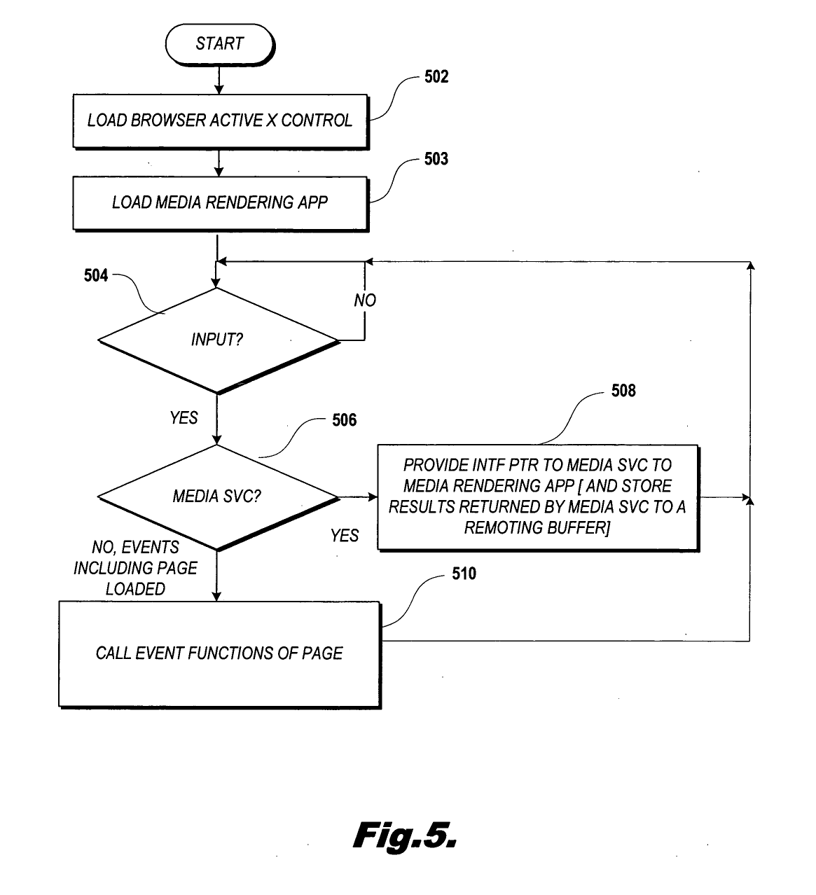

In various embodiments, UPNP server 200 may comprise a number of components adapted to transparently facilitate a media rendering application to render media to a remote UPNP client 110, including in particular, a media service access module adapted to transparently facilitate a media rendering application in accessing media services available on UPNP server 200 to generate display images for rendering onto the remote UPNP client device 110. FIGS. 2-3 illustrate one exemplary embodiment of a UPNP server 200, and example communication exchanges between UPNP server 200 and UPNP client device 110, respectively, and FIGS. 4-5 illustrate selected operations of processes on UPNP server 200, in accordance with some embodiments, all are further described below.

The term “adapted to” as used in the specification and in the claim is substantially synonymous with “designed to”. No further configuration or customization is required to perform a function or an operation, a component is specified or recited as “adapted” to perform. However, in some embodiments, such configuration or customization may be performed.

The term “transparently” as used in the specification and in the claim to qualify an operation, e.g. “transparently facilitating”, “transparently transmitting”, and so forth, refer to the fact that the qualified operation (facilitating, transmitting, and so forth) are performed without the media rendering application being aware or otherwise cognizant of the operation being performed on its behalf.

Continuing to refer to FIG. 1, in various embodiments, UPNP client 110 (or a device attached to it, such as display 115) may be a device adapted to render media, but has no or limited local input functionality. However, the UPNP client 110 (or the device attached to it) would still have the ability to display images, including graphical user interface (GUI) sent from the UPNP server 200. An example of a graphical user interface is an interactive web page, e.g., in HTML (HyperText Markup Language), Flash, JavaScript, VBScript, JScript, PHP (HTML Preprocessor) or XHTML (extensible HyperText Markup Language) form.

Resultantly, since users are generally familiar with the user interfaces of web pages, including sophisticated web pages such as Flash-enabled web pages from Macromedia, Incorporated of San Francisco, Calif., consumption of client device services using a web page based graphical user interface on a client device 110 (e.g., displayed on the client display 115) may be made familiar and user friendly. Further, as will be apparent from the description below, a media rendering application adapted to leverage on media services available from the operating system of UPNP server 200 may be seamlessly deployed to render media from UPNP server 200 to UPNP client 110 (and devices attached to it).

In various embodiments, the UPNP server 200 and UPNP client 110 are coupled to each other wirelessly, i.e., they are members of a wireless network. In other embodiments, the UPNP server 200 and UPNP client 110 are coupled to each other as members of a wire-based network. Regardless of the manner the UPNP server 200 and UPNP client 110 are coupled to each other, for various embodiments, UPNP server 200 and UPNP client 110 are equipped to operate in accordance with the UPNP protocols and specifications promulgated by the UPNP Forum. In various embodiments, UPNP client 110 may be a device to operate in the role of a UPNP control point to control one or more UPNP or non-UPNP rendering devices (e.g. display 115) to render media content available from UPNP server 200 or other UPNP servers, in accordance with the UPNP protocols and specifications. Thus, the terms UPNP server and clients, as used herein, for the purpose of this specification, including the claims, shall be interpreted with the meaning of the server and client being so equipped and communicate with each other, i.e. in accordance with UPNP protocols and specifications. However, in alternate embodiments, server 200 and client 110 may communicate with each other via other communication protocols.

In various embodiments, operating environment 100 is a home-computing environment.

FIG. 2 illustrates an exemplary UPNP server 200 suitable for use in various embodiments of the present invention. In alternate embodiments, the UPNP server 200 may include many more components of those shown in FIG. 2. However, it is not necessary that all of these generally conventional computing components be shown in order to disclose an enabling embodiment for practicing the present invention. As shown in FIG. 2, the UPNP server 200 includes a communications interface 230, which, in some embodiments of the present invention, may be a Network Interface Controller (“NIC”). The inter-device communications of the communications interface 230 may be designed to support a local area network, wide area network, personal area network, telephone network, power line network, serial bus or wireless connection. Such a communications interface 230 would also include the necessary circuitry, driver(s) and/or transceiver for such a connection and would be constructed for use with the appropriate transmission protocols for such connections.

The UPNP server 200 also includes a processing unit 210, an optional display 240 and a memory 150, all interconnected along with the communications interface 230 via a bus 220. The memory 250 generally comprises a random access memory (“RAM”), a read only memory (“ROM”) and a permanent mass storage device, such as a disk drive, flash RAM or the like. The memory 250 stores an operating system 255, an encoder 265 and display definitions 270. For the embodiments, memory 250 further stores a media service access module 280 and media rendering application 286. For the embodiments, media service access module 280 includes container 282 and a generic agent control 284.

Before further describing these elements, it should be noted that while for ease of understanding, operating system 255, encoder 265, display definition(s) 270, media service access module 280, container 282 and generic agent control 284 are described as separate software components, in alternate embodiments, they may be comprised of multiple software components, implemented in hardware, or subparts of one or more integrated software components. Additionally, in alternate embodiments, memory 250 may further store a generator (not shown) equipped to generate the display definitions 270.

In various embodiments, the display definitions 270 may comprise user interface elements (such as scroll bars, buttons, and so forth) for a user to control one or more UPNP rendering devices (e.g. by various rendering device types) to render media contents remoted from UPNP server 200 or other UPNP server.

In various embodiments, operating system 255 provides various media, device and network services to applications executing on UPNP server 200. In various embodiments, the media services include various services for use e.g. by media rendering application 286 to render multi-media, such as audio, video, and the like. In various embodiments, media rendering application 286 is designed to render media leveraging on media services provided by operating system 255. In various embodiments, media rendering application 286 is implemented at least in part in HTML. In other embodiments, at least a portion of media rendering application 286 is implemented in JavaScript, VBScript, JScript, PHP, XHTML or other implementation languages/techniques of the like.

As described earlier, media service access module 280 is adapted to transparently facilitate media rendering application 286 to access media services of operating system 255 to generate display images as part of rendering a media file, as media rendering application 286 is designed to do, however, the display images are transparently transmitted to UPNP client 110 for rendering. Resultantly, media rendering applications 286 may be efficiently developed to render media onto remote client devices, leveraging on available media services, as media rendering applications designed to render media locally. In fact, media rendering applications 286 may be efficiently developed to render media, without being concerned with, or having to be aware of, whether the media are being rendered locally or to remote client devices.

In various embodiments, media service access module 280 includes container 282 and generic agent control 284 adapted to be loaded and operate within container 282, including inheriting properties and methods from container 282. In various embodiments, container 282 is an Active X container, whereas generic agent control 284 is a browser Active X control adapted to handle HTML and XHTML files, in view of display definitions 270. In various embodiments, generic agent control may be adapted to handle other familiar browser files (e.g., Flash, JavaScript, VBScript, JScript, PHP files and the like).

In various embodiments, the display images generated by the media services of operating system 255 may be directed to a storage area of memory 250, for transparent remoting to UPNP client 110. In various embodiments, for selected ones of UPNP client 110 (equipped with appropriate complementary decoders), at least some the rendering display images outputted into the storage area are directed to the encoder 265 for encoding, before being sent to UPNP client 110.

It will be appreciated that the software components may be loaded from a computer readable medium into memory 250 of the UPNP server 200 using a mechanism (not shown) associated with the computer readable medium such as a floppy, tape, DVD (Digital Versatile Disk) /CD (Compact Disk)-ROM drive, flash RAM or communications interface 230.

In various embodiments, the communications interface 230 may facilitate the connection of remote devices to the UPNP server 200. For example, devices for reading and/or writing in machine readable media, digital cameras, printers, digital music players/recorders (such as MP3 players, etc.), smart appliances, digital media adapters, and the like. Various input mechanisms may also be coupled to the UPNP server 200 such as, for example, keyboards and/or mice (not shown).

FIG. 3 illustrates one exemplary series of application level communications between a UPNP server 200 and a UPNP client 110 in accordance with various embodiments. As described earlier, the application level communications are performed in accordance with the UPNP protocol. In FIG. 3, the communications begin with a network discovery request 305. The UPNP client 110 returns a discovery response 310 to the UPNP server 200 with device information about the UPNP client 110. For the illustrated embodiments, the device information includes decoding and display capabilities of the UPNP client 110. The UPNP server 200 then generates/retrieves 315 a display definition or definitions that may or may not be UPNP client device specific.

Next, a display image (e.g. of a GUI) is rendered 320 (e.g. by media rendering application 286) at the UPNP server 200. The UPNP server 200 then encodes 325 the display image (e.g., with encoder 265) into a format for communicating and/or viewing on the UPNP client 110 (or a device attached to it, such as display 115). The encoded image 320 is communicated to the UPNP client 110. The UPNP client 110 then decodes and depicts the encoded image 335 on e.g. display 115.

Next, the UPNP client 110, in various embodiments, receives the 340 user input and communicates 345 user input back to the UPNP server 200. In various embodiments, the display image may be designed to allow UPNP client 110 to also provide commands to other UPNP server/rendering devices in parallel or without providing to UPNP server 200 (e.g. those commands with no effect on the display image).

In various embodiments, different transmission protocols for “remoting” the display image and receiving user inputs may be employed. For example, Microsoft Corporation of Redmond, Wash. has a remote desktop protocol (“RDP”) which may be employed in one embodiment of the present invention for remoting a display image and receiving user input. However, in other embodiments of the present invention the extended personal computer remoting technology version 2 protocol (“XRT2”) may be employed as a simple TCP based command encapsulation protocol for passing messages back and forth between the UPNP server 200 and UPNP client 110. XRT2 is a protocol that is suited to send display drawings and receive user input (such as keystroke commands from a keyboard and/or mouse movements and clicks). The XRT2 protocol was developed by and is made available by Intel Corporation of Santa Clara, Calif. In alternate embodiments, still other protocols may be used to provide a display image to a UPNP client 110 and receive user input from the UPNP client 110 to the UPNP server 200.

Still referring to FIG. 3, once the UPNP server 200 receives user input the user input is processed 350. The UPNP server 200 then determines 355 whether there was a change to the display image and, if so, renders 360 the changed portion of the display image (up to and including a complete change of the display image) to the encoder (e.g. encoder module 265). The changed portion of the display image is then encoded 365 and the encoded changed portion of the display image is sent 370 to the UPNP client 110. The UPNP client 110 then decodes and renders the changed portion of the display image on the client display 115 to update 375 the display image.

In various embodiments, the communications described above and shown in FIG. 3 are merely one exemplary set of communications between the UPNP server 200 and the UPNP client 110. Other communications, both more and fewer, may be employed in other embodiments.

In accordance with the above-described communications between a UPNP server 200 and a UPNP client 110, FIG. 4 illustrates a process within the UPNP server 200 for remoting display images to a UPNP client 110. The remoting process 400 begins at block 405 where a UPNP client is discovered over the network 150. Next, in block 410 a display definition is retrieved for the discovered UPNP client. In block 415, a display image is rendered/redirected to an encoder (e.g., encoder module 265). In one exemplary embodiment the redirection of the display image to the encoder is via piping (e.g., using a UNIX “|” symbol or the like) to redirect the output of a display image (such as, the output of generic agent control 284) to an encoder 265.

In some embodiments, the encoder 265 is actually an optional component, as is the accompanying and block 420 in the remoting process 400, where the display image is encoded. As unencoded (raw) display images generally are of a large size, thus it is often desirable to encode raw display images to reduce processing, bandwidth utilization, memory utilization and/or storage issues when processing, storing and/or communicating display images. Accordingly, various encoding mechanisms may be used such as compressed bitmaps, TIF (Tagged Image Format) images, GIF (Graphical Interchange Format) images, JPG (Joint Photographic Experts Group) images, and the like.

Continuing process 400, in block 425 the encoded display image is sent to the UPNP client 110. Next, looping block 430 begins a loop. While the UPNP client 110 is connected with the UPNP server 200, the following actions are performed. In decision block 435, a determination is made whether input was received from the UPNP client 110. If no input was received, processing essentially loops back and waits until a determination in decision block 435 indicates that input was received. Once input is determined, in decision block 435, to have been received from the UPNP client 110, processing proceeds to block 440 where the UPNP client input is processed.

Next, in decision block 445 a determination is made whether the input from the UPNP client 110 changes the appearance of the display image. Note, the processing of client input may effect other changes at both the client and/or server level, however, the embodiments are directed at the remoting of the display image and are less directed at the specifics of what any one display image, and/or its associated inputs may effectuate. Accordingly, if in decision block 445 no input changes were noted processing loops back to decision block 435. If, however, in decision block 445 it was determined that the client input changed the display image, processing proceeds to block 450 where a determination is made as to what portion of the display image changed.

Block 455 renders the changed portion of the display image to the encoder module 265. Note that while an encoder 265 is referenced as a component of the UPNP server 200, in various embodiments a separate encoder may be implemented in a separate device (not shown). The encoder 265 encodes the rendered display image change in block 460. Next, in block 465, the encoded display image change is sent to the UPNP client 110. Remoting process 400 then proceeds to looping block 470, which cycles back to looping block 430 so long as the UPNP client 110 is connected to the UPNP server 200.

FIG. 5 illustrates selected operations of media service access module 280, in accordance with various embodiments. As illustrated, on invocation, i.e. the loading of (Active X) container 282 into memory 250, generic agent (e.g. browser (Active X)) control 284, inheriting from container 282, is loaded to operate within container 282, block 502. Further, media render application 286 is loaded onto generic agent (e,g, browser (Active X)) control 284, block 503.

Thereafter, generic agent (browser (Active X)) control 284 (including methods inherited from (Active X) container 282), awaits for input, block 504. The input may be an attempted access of a media service (provided by operating system 255) by media rendering application 286, an event at UPNP server 200, or an event at UPNP client 110 (including from a device attached thereto). An example of an event at UPNP sever 200 may be a notification of the loading completion of a HTML page of media rendering application 286. Whereas, an example of an event at UPNP client 110 may be a user input (e.g., an input provided using remote control 120).

Accordingly, on receipt of an input, generic agent (browser (Active X)) control 284 determines the nature of the input, block 506. If it is determined that the input is an attempted access of a media service (provided by operating system 255) by media rendering application 286, generic agent (browser (Active X)) control 284 returns an interface pointer to the media service to media rendering application 286, block 508. The media rendering application 286, in turn, uses the interface pointer to access the media service. In various embodiments where container is an Active X container and generic agent control 284 is a browse Active X control, control 284 returns the IDISPATCH interface pointer of the media service object to media rendering application 286.

In various embodiments, on performing any applicable processing by the invoked media service, in response to the invocation, if applicable, the invoked media service transmits to UPNP client 110, a location identifier (e.g. a uniform location identifier (URI)) identifying a location on server 200 where UPNP client 110 may retrieve the media to be rendered. As described earlier, the media may comprise audio and/or video. The transmission may be accomplished using e.g. the HTTP protocol. In other embodiments, other protocols may be employed. In response, the UPNP client 110 accesses the media using the provided URI, and on retrieval, renders the retrieved media. In other embodiments, the media returned by the accessed media service may be redirected onto a remoting buffer in memory 250, to facilitate subsequent transparent remoting to UPNP client 110. The buffered media may be transparently (encoded and) transmitted to UPNP client 110 in due course. Accordingly, accesses to media service provided by operating system may be transparently facilitated for media rendering application 286.

On the other hand, if it is determined at block 506, that the input is the notification of an event, generic agent (browser (Active X)) control 284 either processes the event or call an appropriate event function to process the event accordingly, block 510. Specifically, for the embodiments, if the event is a notification of the loading completion of a HTML page of media rendering application 286, browser (Active X) control 284 calls the event functions defined in the HTML page of media rendering application 286 that are supposed to be called at initialization. These event functions defined in the HTML page of media rendering application 286 may include event functions for handling pre-defined events associated with the usage of the media services provided by operating system 255. Likewise, browser (Active X) control 284 calls an appropriate event function defined in the current HTML page of media rendering application 286, if the event is an event at UPNP client 110, and the event is also one of the pre-defined events associated with the usage of the media services provided by operating system 255. In various embodiments, browser (Active X) control 284 obtains the IHTML document interface pointer of the current HTML page of media rendering application 286, prior to invoking the event functions defined therein. Accordingly, events (including inputs) from UPNP client 110, associated with remoting media onto UPNP client 110, may also be transparently facilitated for media rendering application 286.

Thus, together with the earlier described process for remoting display image onto UPNP client 110, remoting of media onto UPNP client 110 may be transparently facilitated for media rendering application 286.

Although specific embodiments have been illustrated and described herein, it will be appreciated by those of ordinary skill in the art and others, that a wide variety of alternate and/or equivalent implementations may be substituted for the specific embodiment shown in the described without departing from the scope of the present invention. This application is intended to cover any adaptations or variations of the embodiment discussed herein. Therefore, it is manifested and intended that the invention be limited only by the claims and the equivalents thereof.

What is claimed:

1. A method for rendering a media file on a client device, comprising:
transparently facilitating a media rendering application in accessing one or more media services on a server remotely disposed away from, but communicatively coupled to the client device, to assist in rendering the media file to the client device; and
the media services assisting the media rendering application in rendering the media file from the server to the client device.

2. The method of claim 1, wherein at least a portion of the media rendering application is implemented in HTML, and the one or more media services comprise media services offered by an operating system of the server to a browser of the server adapted to host HTML applications.

3. The method of claim 1, wherein the transparent facilitating comprises launching on the server a container, and a generic agent control inheriting from the container;
launching the media rendering application onto the generic agent control;
receiving by the container an attempt to access one of the one or more media services by the media rendering application, to generate or contribute towards generating the display image as part of the rendering of the media file;
in response, returning by the container to the media rendering application an interface pointer to the media service; and
accessing the media service, in turn, by the media rendering application using the returned interface pointer.

4. The method of claim 3, wherein the container is an Active X container, the generic agent control is a browser Active X control, and the launching of a generic agent control comprises launching the browser Active X control inheriting form the Active X container.

5. The method of claim 3, wherein the generic agent control is a browser control, the media rendering application is adapted for execution within a browser, and the launching of a media rendering application onto the generic agent control comprises launching the media rendering application onto the browser control.

6. The method of claim 1, wherein the assisting comprises transmitting to a digital media adapter device, to which the client device is attached, a location identifier identifying a location on the server where the media file to be rendered can be retrieved.

7. The method of claim 1, wherein the assisting comprises transmitting the media file to the client device through a digital media adapter device.

8. The method of claim 1, further comprises transparently routing an event occurred at the client device to an event handling function of the media rendering application to handle, and the event is a pre-defined event associated with usage of the one or more media services.

9. The method of claim 8, wherein the transparent routing comprises transparently receiving by a generic agent control on which the media rendering application is loaded, a notification of the event; and
in response, the generic agent control invoking the event handling function of the media rendering application.

10. The method of claim 8, wherein the event comprises an event associated with an input provided by a user to the client device using a remote control device.

11. An electronic device for rendering a media file on a client device remotely disposed away from, but coupled to the electronic device, comprising:
a processor; and
a media service access module adapted to be operated by the processor to transparently facilitate a media rendering application in using one or more media services to assist in rendering the media file from the electronic device to the client device.

12. The electronic device of claim 11, further comprising an operating system adapted to be operated by the processor, including the one or more media services which are offered to a browser adapted to host HTML applications, wherein at least a portion of the media rendering application is implemented in HTML.

13. The electronic device of claim 11, wherein the media access service module comprises a container and a generic agent control inheriting from the container, wherein
the generic agent control is designed to have the media rendering application launched thereon,
the container is adapted to return to the media rendering application an interface pointer to the media service, in response to receipt of an attempt to access one of the one or more media services by the media rendering application, to generate or contribute towards generating the display image as part of the rendering of the media file, and
the media rendering application is adapted to access the media service, in turn, using the returned interface pointer.

14. The electronic device of claim 13, wherein the container is an Active X container, the generic agent control is a browser Active X control adapted to be inheriting from the Active X container.

15. The electronic device of claim 13, wherein the generic agent control is a browser control, the media rendering application is adapted for execution within a browser, and the media rendering application is launched onto the browser control.

16. The electronic device of claim 11, wherein the electronic device comprises a selected one of a desktop computer and a set-top box.

17. The electronic device of claim 11, wherein the media service access module is further adapted to transparently route an event occurred at the client device to an event handling function of the media rendering application to handle, and the event is a pre-defined event associated with usage of the one or more media services.

18. The electronic device of claim 17, wherein the media service access module comprises a generic agent control adapted to receive a notification of the event, and in response, invoked the event handling function of the media rendering application.

19. The electronic device of claim 17, wherein the event comprises an event associated with an input provided by a user to the client device using a remote control device.

20. A computer readable medium comprising:
a storage medium;
computer executable instructions stored in the storage medium, adapted to enable an apparatus to perform the operations set forth in claim 1.

21. The computer readable medium of claim 20, wherein the computer executable instructions are further adapted to enable the apparatus to perform the additional operations set forth in claim 8.

22. A system comprising:
a communication interface to couple the system to a client device;
a memory;
a disk drive coupled to bus having stored therein computer executable instructions designed to enable the system to:
transparently facilitate a media rendering application in using one or more media services to assist in rendering a media file for the client device; and
a processor coupled to the communication interface, the memory, and the disk storage.

23. The system of claim 22, wherein the instructions implement a container and a generic agent control inheriting from the container, wherein
the generic agent control is designed to have the media rendering application launched thereon,
the container is adapted to return to the media rendering application an interface pointer to the media service, in response to receipt of an attempt to access one of the one or more media services by the media rendering application, to generate or contribute towards generating the display image as part of the rendering of the media file, and
the media rendering application is adapted to access the media service, in turn, using the returned interface pointer.

24. The system of claim 22, wherein the instructions are further adapted to transparently route an event occurred at the client device to an event handling function of the media rendering application to handle, and the event is a pre-defined event associated with usage of the one or more media services.

25. The system of claim 24, wherein the instructions are further adapted to receive a notification of the event, and in response, invoke the event handling function of the media rendering application.

26. The system of claim 24, wherein the event comprises an event associated with an input provided by a user to the client device using a remote control device.
